(19) United States
(12) Patent Application Publication
(10) Pub. No.: US 2012/0244276 A1
(43) Pub. Date: Sep. 27, 2012

(54) METHOD FOR DEPOSITING A PALLADIUM LAYER SUITABLE FOR WIRE BONDING ON CONDUCTORS OF A PRINTED CIRCUIT BOARD, AND PALLADIUM BATH FOR USE IN SAID METHOD

(75) Inventors: Jochen Heber, Neuenbuerg (DE); Erwin Marka, Koenigsbach-Stein (DE); Walter Macht, Pforzheim (DE); Silke Oelschlaeger, Birkenfeld (DE)

(73) Assignee: Doduco GmbH, Pforzheim (DE)

(21) Appl. No.: 13/505,800

(22) PCT Filed: Nov. 6, 2010
(86) PCT No.: PCT/EP10/06769

§ 371 Date: Jun. 11, 2012

(30) Foreign Application Priority Data
Nov. 10, 2009 (DE) 10 2009 053 302.8
Mar. 13, 2010 (DE) 10 2010 011 269.0

(51) Int. Cl. C23C 18/31; B05D 1/18

(52) U.S. Cl. 427/99.5; 106/1.28

(57) ABSTRACT

A method for generating a surface that can be bonded with gold wire. The surface is obtained by first depositing an exchange palladium layer made of the electrolyte on conductors of printed circuit boards, in particular on conductors made of copper or conductive paste. The exchange palladium layer is then reinforced with a palladium layer, deposited from a chemical palladium electrolyte. In order to protect the palladium, an exchange gold layer is then applied. An exchange palladium bath is used, comprising an organic brightener.

### CROSS-REFERENCE TO RELATED APPLICATIONS

This application is a National Stage application of International Application No. PCT/EP2010/006769, filed on Nov. 6, 2010, which claims priority of German patent application number 10 2010 011 269.0, filed on Mar. 13, 2010 and German patent application number 10 2009 053 302.8, filed on Nov. 10, 2009, all of which are incorporated herein by reference in their entireties.

### BACKGROUND OF THE INVENTION

1. Field of the Invention

The present invention relates to the field of metal particle deposition. More specifically, the present invention relates to a method for depositing a palladium layer for wire bonding on conductors of a printed circuit board, and a palladium bath for use in the method.

2. Description of the Prior Art

The invention is related to a method comprising the step of depositing palladium layers suitable for bonding on conductors of printed circuit boards by depositing palladium from a palladium exchange bath containing an organic brightener. A method of this type is known from WO 2006/074902 A2. According to the known method, initially nickel is deposited from a chemical nickel bath by chemical reduction, i.e. without applying external current, on conductors made of copper that are situated on an organic or ceramic printed circuit board. It is also feasible to deposit a nickel alloy, rather than nickel, from a corresponding nickel alloy bath without applying external current. A thin palladium layer of between 10 nm and 40 nm in thickness is then deposited by charge exchange from a palladium exchange bath onto the nickel layer or nickel alloy layer. The palladium exchange bath usually consists of an inorganic or organic acid and the palladium salt of said acid as well as of an inorganic compound of at least one of the elements copper, thallium, selenium and tellurium, preferably copper sulfate. The pH value of the palladium exchange bath is less than 1, i.e. the bath is strongly acidic. A palladium exchange bath is also called palladium immersion bath or palladium activation bath, the deposition from which is called deposition by immersion coating or activation.

Finally, a cover layer made of gold having a thickness of less than 0.1 μm is deposited on the palladium layer. It is preferred to deposit the gold from a gold exchange bath. The gold layer can be increased to larger thickness by autocatalytic deposition from a chemical gold bath, i.e. by reductive deposition.

First of all the palladium serves as a basis for later attachment of wires made of gold or aluminum by bonding. Moreover, said Pd layer is to prevent the diffusion of nickel to the gold surface in order to maintain the ability to be bonded. The purpose of the gold layer is to protect the surface of the palladium from chemical changes to which it is subject due to its high catalytic reactivity, which can lead, e.g., to the so-called “brown powder” effect.

According to the disclosure presented in WO 2006/074902 A2, it was noted that the existing requirements with regard to the ability for multiple soldering and bonding can be met only if an inorganic compound of at least one of the elements, copper, thallium, selenium, and tellurium, in particular copper sulfate, is added to the palladium bath in addition to the palladium salt. In the absence of added inorganic compounds of at least one of said elements to the palladium exchange bath, no sufficient adhesion and barrier effect of the palladium layer was obtained.

Methods are known in the market for the coating of copper leads on printed circuit boards according to which palladium is initially deposited from a customary palladium exchange bath onto the copper. More palladium is then deposited onto the first layer from a chemical (reductive) palladium bath and finally a gold layer is deposited to serve as cover layer. The known method leads to a build-up of layers, which, according to the recommendation of the manufacturer, is suitable for soldering, but not for bonding of wires made of gold and aluminum.

Also known in the market is a method said to lead to bondable surfaces on copper conductors of printed circuit boards. The method involves palladium being initially deposited from a customary palladium activation bath onto the copper conductors. A nickel layer is then deposited thereon from a chemical (reductive) nickel bath. Another palladium layer is deposited onto the nickel layer from a customary palladium activation bath and said palladium layer is increased in thickness by deposition of palladium from a chemical (reductive) palladium bath. Finally, the palladium surface is protected by a gold layer prepared by immersion coating. This known method involves extraordinary effort.

### SUMMARY OF THE PRESENT INVENTION

It is the object of the present invention to provide an alternative method according to which palladium layers capable of bonding can be deposited on conductors of printed circuit boards, in particular on conductors made of copper, with moderate effort.

Said object is met by a method having the features specified in claim 1, namely, a method for depositing palladium layers for bonding on conductors of printed circuit boards comprising the step of depositing palladium from a palladium exchange bath containing an organic brightener. The subject matter of claim 10 is a palladium bath that is particularly well-suited for carrying out said method, namely, a palladium exchange bath for use in a method for depositing palladium layers suitable for bonding on conductors of printed circuit boards by depositing palladium from a palladium exchange bath, containing the palladium in the form of a palladium salt in an aqueous acidic solution, and containing an organic brightener selected from the group of compounds consisting of:

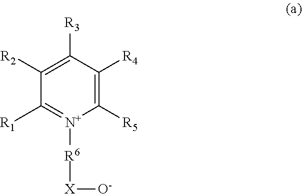

in which

R₁ to R₅ each is a hydrogen atom or halogen atom or a formyl, carbamoyl, C₁₋₄ alkyl, amino, phenyl or benzyl group, whereby the alkyl, phenyl, and benzyl fraction can optionally be replaced by one or more hydroxyl groups or amino groups or by halogen atoms,

R₆ is a radical having 1-6 C atoms that is derived from a saturated or unsaturated aliphatic hydrocarbon, whereby the radical can be substituted and X is an SO₂ group or a CO group, and
(b) benzaldehydes.

### BRIEF DESCRIPTION OF THE DRAWINGS

### DETAILED DESCRIPTION OF THE INVENTION

According to the invention, palladium layers are deposited by a charge exchange on conductors of printed circuit boards, in particular on conductors made of copper, from a palladium exchange bath that contains an organic brightener.

This provides the person skilled in the art with another method, aside from the method known from WO 2006/074902 A2, for depositing a palladium layer capable of bonding on conductors of printed circuit boards. This method has the following additional advantages:
The palladium layer can be deposited not only on conductors that have previously been coated with nickel, but also directly on a conductor made of copper.
An intermediary nickel layer, as is known in the prior art, is thus dispensable.
Since an intermediary layer made of nickel is dispensable, the palladium coating is also suitable for high frequency applications, in which nickel is not well-suited due to its magnetic property.
The palladium layers that are deposited from a palladium exchange bath containing an organic brightener have proven to be extraordinarily dense, fine-grained, and even. In contrast to a conventional palladium activation bath, a suitable base is thus generated to a further increase of the thickness of the palladium layers using palladium from a reductive Pd bath. A reductive deposition of palladium of this type from a chemical palladium bath preferably proceeds to generate a thickness of 0.05 μm to 0.5 μm, in particular of 0.1 μm to 0.3 μm. This is more than the thickness of the palladium layer underneath, which was deposited from a palladium exchange bath according to the invention, and is particularly well-suited for attachment of wires made of gold or aluminum by means of bonding and is advantageous as a refinement of the invention.
Expediently, the pH value of the bath according to the invention is maintained at less than 4. It is particularly preferred to operate the bath according to the invention at a pH value of 2.
The palladium exchange bath according to the invention is sufficiently stable.

Suitable organic brighteners include, in particular, compounds from the group of compounds specified in claim 2. 3-(1-pyridinio)-1-propane sulfonate is particularly preferred as brightener and obtained in the case, in which residues R₁ to R₅ in the general formula are hydrogen, residue R₆ is —CH₂—CH₂—CH₂—, and in which X is SO₂. In the absence of such a compound, the palladium deposited from the exchange bath appears dark to black, especially in and at the holes of a printed circuit board, which leads to the conclusion that the deposition is porous to sponge-like. However, a markedly better, brighter, more even, and optically pleasing palladium layer is generated in the presence of said organic compound in the palladium exchange bath.

Expediently, the bath contains the organic brightener at a concentration of 0.01 to 50 g per liter, preferably at a concentration of 1 to 10 g per liter. Particularly good results have been obtained when the concentration of the 3-(1-pyridinio)-1-propane sulfonate in the palladium exchange bath was from 3 to 6 g per liter. At lower concentrations, the effectiveness of the brightener in the palladium exchange bath decreases. With increasing concentration of the brightener, the deposition rate decreases meaning that the concentration of the organic brightener should not exceed 50 g per liter.

Expediently, palladium is present in the palladium exchange bath according to the invention in an amount of 150 mg per liter to 250 mg per liter, preferably in the form of a palladium chloride solution. Lower concentrations lead to increased or inappropriately long dwell time in the bath required to attain the desired thickness of the layer. For this reason, the palladium concentration should not be less than 150 mg per liter. With increasing palladium concentration, the deposition rates attained increase and layers exceeding a thickness of 50 nm can be obtained. However, the porosity of the palladium layer also increases in this case and the uniformity and homogeneity of the palladium layer decrease, and the conductor beneath the palladium layer might possibly be attacked too strongly by replacement of the less noble metal, of which the conductor consists by the nobler palladium. For this reason, it is preferred to limit the concentration of palladium in the exchange bath to 250 mg per liter.

Further suitable brighteners include benzaldehydes, in particular benzaldehyde-2-sulfonic acid at a concentration of 0.1 to 50 g per liter, preferably approx. 1 g per liter.

Palladium is preferably present in the palladium exchange bath in the form of palladium chloride and dissolved in hydrochloric acid. However, it is feasible just as well to form the palladium exchange bath using other salts, e.g. with palladium sulfate, dissolved in sulfuric acid, or with palladium phosphate, dissolved in phosphoric acid, or with palladium acetate, dissolved in acetic acid. However, the use of palladium chloride in hydrochloric acid is preferred since said bath has proven to be particularly stable.

For stabilization, the palladium exchange bath according to the invention preferably further contains an inorganic complexing agent in an amount of up to 150 g per liter, preferably in an amount from 30 to 80 g per liter. The bath is not very sensitive to changes in the concentration of the inorganic complexing agent, although the deposition rate decreases with increasing concentration of the complexing agent such that the concentration should not exceed 150 g per liter, preferably 80 g per liter.

Ammonium salts are particularly well-suited as inorganic complexing agents, whereby the anion thereof should preferably be the same as that of the palladium salt. Accordingly, if palladium chloride is used in the palladium exchange bath, as is preferred, the inorganic complexing agent should also be a chloride, in particular ammonium chloride. If palladium sulfate is used as palladium salt, it is recommended to also use a sulfate as inorganic complexing agent, in particular ammonium sulfate. If palladium acetate is used as palladium salt, then the inorganic complexing agent should also be an acetate, in particular ammonium acetate, etc. . . . However, is would also be feasible to use a cation different from ammonium in the inorganic complexing agent, e.g. sodium or potassium, but ammonium salts allow slightly better stability of the bath to be attained.

It has been found that the addition of an organic complexing agent can improve the deposition of palladium from the palladium exchange bath even further. In particular the tendency of said palladium baths to form spots of blotched or cloudy darker depositions on extensive contiguous surfaces of a less noble substrate can be reduced. This beneficial effect of the organic complexing agent supports the beneficial effect of the organic brightener used according to the invention in order to attain an evenly bright, dense, and fine-grained palladium deposit. Moreover, it has been found that the organic complexing agent markedly improves the stability of the bath, in particular upon more extensive throughput of printed circuit boards through the bath.

Well-suited as organic complexing agents are, in particular, carbonic acids, amines, EDTA, and EDTA derivatives. Diethylene triamine has proven to be particularly well-suited, in particular at a concentration between 0.01 ml per liter and 5 ml per liter. The deposition rate decreases with increasing concentration of the organic complexing agent in the palladium exchange bath.

It is expedient to maintain the palladium exchange bath at a temperature between room temperature and 60° C. during the deposition process, preferably at a temperature in the range from 35° C. to 50° C. This range has proven to be particularly well-suited. Using the stated temperature and a bath of the preferred composition, the desired thickness of the layer, which preferably is 25 nm to 35 nm and should not exceed 50 nm, can be deposited within 5 minutes. Preferably, the deposition process is limited to 2 to 3 minutes.

As mentioned above, the palladium exchange bath according to the invention should preferably be adjusted to a pH value of 2. In a hydrochloric acid bath containing palladium in the form of palladium chloride and ammonium chloride as the inorganic complexing agent, the pH value can be adjusted through the addition of hydrochloric acid or ammonia. At pH values higher than pH=2, palladium is complexed more extensively, i.e. less free palladium is available for deposition. Accordingly, the deposition rate decreases with increasing pH value. At a pH above 4, there is no longer any significant deposition.

The palladium layer deposited from the palladium exchange bath can be increased in thickness by depositing more palladium from a chemical palladium bath by means of a reduction agent. The palladium layer deposited from the palladium exchange bath according to the invention is a particularly well-suited substrate for said increase of the thickness of the palladium layer since it is extraordinarily dense, fine-grained, and even due to the use of the organic brightener. In particular, there is no need to have a nickel layer as diffusion barrier layer preventing the diffusion of copper into the palladium layer beneath the palladium layer generated by reductive deposition of palladium. It may be recommendable to have a nickel layer beneath the palladium layer deposited from a palladium exchange bath if said layer is not increased in thickness by depositing more palladium from a reductive palladium bath. Increasing the thickness enables palladium layers that are several μm thick. However, for bonding, palladium layers that are several μm thick are no longer economically reasonable. The preferred range of the thickness of the palladium layer for bonding is 50 nm to 500 nm.

Suitable chemical (reductive) baths for the deposition of palladium are known. A well-suited bath has the following composition:
0.5 to 3 g per liter of palladium in the form of a dissolved chloride, sulfate, acetate, phosphate or the like salt, or palladium bound in a complex, e.g. as chloro complex, amino complex, nitrito complex or the like.
As reducing agent, 5 to 50 g per liter of sodium hypophosphite or 1 to 50 g per liter of sodium formiate or 1 to 50 g per liter of formic acid.
Inorganic complexing agents, e.g. sodium citrate, malonic acid salts, succinic acid salts, potassium phosphate, potassium dihydrogen phosphate, ammonium sulfate.
Organic complexing agents, e.g. EDTA, EDTA derivates, amines such as, e.g., triethanolamine, tris-(2-aminoethyl)-amines, diethylene triamine, triethylene tetramine, 1,3-diaminopropane, each of them either alone or in combination.

In addition, the chemical palladium bath can contain further ingredients, mainly stabilizers and accelerators that are known to the person skilled in the art from EP 0 698 130B1.

A chemical palladium bath of said type is operated at temperatures between 40° C. and 90° C., in particular at a temperature of approx. 70° C. Depending on the desired thickness of the layer, coating times from 30 minutes to 60 minutes are possible. The known chemical palladium baths usually operate in the weakly acidic to weakly alkaline range. In chemical palladium baths of the type described above, it is feasible to operate at a pH value of 8.

The most important steps of an exemplary method for palladium deposition are described in the following, whereby a chemical palladium bath as described above can be used and a palladium exchange bath containing 150 to 250 mg of palladium in the form of palladium chloride per liter, 50 g of ammonium chloride per liter, 3 g of 3-(1-pyridinio)-1-propane sulfonate per liter, and 1 to 5 ml of diethylene triamine per liter are used, which can be operated at 35° C. to 50° C. and at a pH value of 2.

Treatment of a printed circuit board having conductors, which are made of copper, using said baths can comprise the following steps:

1. Degreasing in a weakly acidic de-greasing bath

2. Rinsing with water

3. Immersing in an etching solution for activation of the copper surface

4. Rinsing

5. Coating with palladium in a palladium exchange bath according to the invention

6. Immersing in a diluted hydrochloric acid solution in order to remove foreign seeds from the surface of the palladium

7. Rinsing with water

8. Depositing palladium in a chemical (reductive) palladium bath

9. Immersing in a static rinse in order to collect residual palladium bath material adhering to the printed circuit board and prevent carry-over thereof into subsequent baths

10. Rinsing with water

11. Depositing a gold flash

12. Immersing in a static rinse

13. Rinsing with water.

14. Drying.

The deposition of a gold flash with a thickness that can be, e.g., 20 nm to 30 nm, is customary for protection of palladium surfaces and known to the person skilled in the art. The gold is preferably deposited from an exchange bath.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A method for depositing palladium layers for bonding on conductors of printed circuit boards, said method comprising the step of depositing palladium from a palladium exchange bath containing an organic brightener.

2. The method according to claim 1, wherein the organic brightener is selected from the group of compounds consisting of: 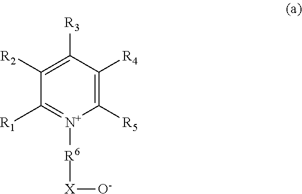
in which
R₁ to R₅ each is a hydrogen atom or halogen atom or a formyl, carbamoyl, C₁₋₄ alkyl, amino, phenyl or benzyl group, whereby the alkyl, phenyl, and benzyl fraction can optionally be replaced by one or more hydroxyl groups or amino groups or by halogen atoms,
R₆ is a radical having 1-6 C atoms that is derived from a saturated or unsaturated aliphatic hydrocarbon, whereby the radical can be substituted and X is an SO₂ group or a CO group, and
(b) benzaldehydes.

3. The method according to claim 2, wherein said organic brightener is selected from the group consisting of 3-(1-pyridinio)-1-propane sulfonate and benzaldehyde-2-sulfonic acid.

4. The method according to claim 1, further comprising the step of adjusting and maintaining the concentration of the organic brightener in the palladium exchange bath at a value between 0.01 g per liter and 50 g per liter.

5. The method according to claim 4, further comprising the step of using 3-(1-pyridinio)-1-propane sulfonate at a concentration of 3 g per liter to 6 g per liter or benzaldehyde-2-sulfonic acid at a concentration of 1 g per liter.

6. The method according to claim 1, further comprising the step of maintaining the palladium exchange bath at a temperature between room temperature and 60° C. during the deposition.

7. The method according to claim 1, further comprising the step of operating the palladium exchange bath at a pH value of less than 4.

8. The method according to claim 1, wherein the dwell time of the printed circuit board in the palladium exchange bath is no more than 5 minutes.

9. The method according to claim 1, further comprising the step of depositing palladium from a chemical reductive palladium bath after the step of depositing palladium from the palladium exchange bath.

10. A palladium exchange bath for use in a method for depositing palladium layers suitable for bonding on conductors of printed circuit boards by depositing palladium from a palladium exchange bath, containing the palladium in the form of a palladium salt in an aqueous acidic solution, and containing an organic brightener selected from the group of compounds consisting of: 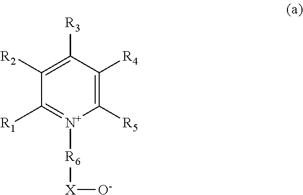
in which
R₁ to R₅ each is a hydrogen atom or halogen atom or a formyl, carbamoyl, C₁₋₄ alkyl, amino, phenyl or benzyl group, whereby the alkyl, phenyl, and benzyl fraction can optionally be replaced by one or more hydroxyl groups or amino groups or by halogen atoms,
R₆ is a radical having 1-6 C atoms that is derived from a saturated or unsaturated aliphatic hydrocarbon, whereby the radical can be substituted and X is an SO₂ group or a CO group, and
(b) benzaldehydes.

11. The palladium exchange bath according to claim 10, wherein the brightener is selected from the group consisting of 3-(1-pyridinio)-1-propane sulfonate and benzaldehyde-2-sulfonic acid.

12. The palladium exchange bath according to claim 10, containing palladium in an amount of 150 mg per liter to 250 mg per liter.

13. The palladium exchange bath according to claim 10, containing palladium in the form of palladium chloride.

14. The palladium exchange bath according to claim 10, containing the organic brightener at a concentration of 0.01 to 50 g per liter.

15. The palladium exchange bath according to claim 10, containing 3-(1-pyridinio)-1-propane sulfonate at a concentration of 3 g per liter to 6 g per liter or benzaldehyde-2-sulfonic acid at a concentration of 1 g per liter.

16. The palladium exchange bath according to claim 10, further containing an inorganic complexing agent in an amount of up to 150 g per liter.

17. The palladium exchange bath according to claim 16, containing 30 to 80 g of the inorganic complexing agent per liter.

18. The palladium exchange bath according to claim 16, wherein the inorganic complexing agent is an ammonium salt.

19. The palladium exchange bath according to claim 18, wherein the ammonium salt is ammonium chloride.

20. The palladium exchange bath according to claim 10, containing diethylene triamine as organic complexing agent, at a concentration between 0.01 ml per liter and 5 ml per liter.

21. The method according to claim 1, wherein the palladium layers are deposited on conductors made of copper.

22. The method according to claim 4, further comprising the step of adjusting and maintaining the concentration of the organic brightener in the palladium exchange bath at a value between 1 g per liter and 10 g per liter.

23. The method according to claim 6, wherein the bath is maintained at a temperature in the range from 35° C. to 50° C.

24. The method according to claim 7, wherein the bath is operated at a pH value of 2.

25. The method according to claim 8, wherein the dwell time of the printed circuit board in the palladium exchange bath is 2 to 3 minutes.

26. The palladium exchange bath according to claim 14, containing the organic brightener at a concentration of 1 g per liter to 10 g per liter.
